(19) United States
(12) Patent Application Publication
(10) Pub. No.: US 2021/0046599 A1
(43) Pub. Date: Feb. 18, 2021

(54) MACHINE TOOL SYSTEM

(71) Applicant: OKUMA Corporation, Niwa-gun (JP)

(72) Inventor: Shoichi MORIMURA, Niwa-gun (JP)

(21) Appl. No.: 16/992,720

(22) Filed: Aug. 13, 2020

(30) Foreign Application Priority Data
Aug. 14, 2019 (JP) 2019-148876

(51) Int. Cl. B23Q 7/04; B23Q 11/10; B23Q 17/00

(52) U.S. Cl. CPC B23Q 7/046; B23Q 17/006; B23Q 11/10

(57) ABSTRACT

A disclosed system enables easy installation and removal of an in-machine robot for use in a machine tool and further enables easy replacement of a robot with another robot to suit an intended purpose. A machine tool system includes a machine tool with a cover that covers a machining space, and a robot unit on which an articulated robot is mounted. A portion of the cover of the machine tool has an opening to allow insertion of the articulated robot of the robot unit into the machining space through the opening. The articulated robot of the robot unit is inserted through the opening, and the opening is closed by a lid of the robot unit.

### CROSS REFERENCE TO RELATED APPLICATION

This present invention claims priority under 35 U.S.C. § 119 to Japanese Patent Application No 2019-148876 filed on Aug. 14, 2019, the entire content of which is incorporated herein by reference.

### TECHNICAL FIELD

The present disclosure relates to a machine tool system, in particular, a machine tool system that includes an in-machine robot.

### BACKGROUND

A need exists for further automation of machine tools. One measure to enhance automation is to employ a robot inside a machine tool. Use of a robot enables a variety of operations such as attaching and detaching of tools and workpieces; cleaning of the space inside the machine tool, tools, and workpieces; repression of adherence of swarf; and prevention of workpiece chatter.

As a structure for a robot, JP H03-82155 U discloses a structure that includes a pair of main shutters having recesses on their opposing edges, the recesses being sized to allow movement of a robot arm, wherein a drive mechanism causes the main shutters to move together in an opening or closing direction to open or close a robot arm insertion hole; and a pair of auxiliary shutters each attached to a corresponding one of the main shutters to be movable vertically and horizontally for covering the recesses.

With the goal of preventing an operator and a robot arm from interfering with each other without significantly limiting the movement of the robot arm, JP 2019-25555 A discloses a workpiece transport device that includes a base; a robot arm having a workpiece gripper configured to grip a workpiece, the robot arm being integral with the base and configured to move the workpiece gripped by the workpiece gripper; and a cover that is integral with the base and configured to isolate the operating space of the robot arm from the outside.

The robot provided inside the machine tool enables various operations, but is not used for all operations; that is, depending on a workpiece type, some operations are performed without using the robot. The robot may be changed to another one depending on the intended task. For example, a high-speed robot and a heavy load carrying robot are used for different types of tasks. Removal or installation of robots as need arises is not easy if the robots are installed inside a machine tool.

### SUMMARY

The present disclosure provides a technique that enables easy installation and removal of an in-machine robot for use in a machine tool and further enables easy replacement of a robot with a different robot to suit an intended purpose.

According to one aspect of the present disclosure, there is provided a machine tool system comprising a machine tool with a cover that covers a machining space; and a robot unit on which an articulated robot is mounted, wherein a portion of the cover of the machine tool has an opening to allow insertion of the articulated robot of the robot unit into the machining space through the opening, and wherein the robot unit comprises closure means for closing the opening after the articulated robot is inserted.

According to the present disclosure, the machine tool and the robot unit are separate devices, the machine tool and the robot unit are connected to each other as needed, and the articulated robot of the robot unit is inserted into a machining chamber through the opening of the machine tool. The articulated robot that is inserted into the machining chamber is operable as an in-machine robot for the machine tool. The articulated robot can be removed from the machine tool or replaced with another robot to suit an intended purpose by disconnecting the robot unit from the machine tool.

In one embodiment of the present disclosure, the robot unit includes a base to which the articulated robot is attached, and a stocker. This configuration enables connecting the articulated robot and the stocker to the machine tool at the same time.

In another embodiment of the present disclosure, the robot unit further comprises a coolant tank that is integral with the robot unit. This configuration enables easily preventing cutting water from leaking to a floor below the machine tool.

In still another embodiment of the present disclosure, the robot unit further comprises a positioning mechanism for placing the robot unit in position with respect to the machine tool. This configuration enables reliably connecting the robot unit to the machine tool.

In still another embodiment of the present disclosure, a plurality of types of articulated robots are mounted on the robot unit. This configuration enables serving a plurality of purposes by selecting and connecting an appropriate robot unit to the machine tool.

In still another embodiment of the present disclosure, the machine tool comprises a controller for controlling operation of the machine tool, wherein a connection of the robot unit to the machine tool enables the controller to control the articulated robot. This configuration enables the controller of the machine tool to collectively control operation of the machine tool and operation of the articulated robot.

In still another embodiment of the present disclosure, the connection of the robot unit to the machine tool causes the controller to indicate that the connection has been made. This configuration enables an operator to recognize that the articulated robot is ready for use as an in-machine robot.

In still another embodiment of the present disclosure, the controller causes the articulated robot to extend to outside the machine tool. This configuration enables accessing components placed outside the machine tool, such as a tool stocker or a workpiece stocker, using the articulated robot.

According to the present disclosure, the in-machine robot for the machine tool can be easily installed and removed. Further, the robot can be easily replaced with another robot to suit an intended purpose.

### BRIEF DESCRIPTION OF DRAWINGS

Embodiments of the present disclosure will be described based on the following figures, wherein:

FIG. 1 illustrates a structure of a machine tool system according to an embodiment;

FIG. 2 illustrates a first connection state of the robot unit according to the embodiment;

FIG. 3 illustrates a second connection state of the robot unit according to the embodiment;

FIG. 4 illustrates an operation state of an articulated robot according to the embodiment;

FIG. 5 illustrates a structure of a machine tool system according to a second embodiment;

FIG. 6 illustrates a first connection state of a robot unit according to the second embodiment;

FIG. 7 illustrates a second connection state of the robot unit according to the second embodiment; and

FIG. 8 illustrates a third connection state of the robot unit according to the second embodiment.

### DESCRIPTION OF EMBODIMENTS

Embodiments of the present disclosure will now be described with reference to the drawings.

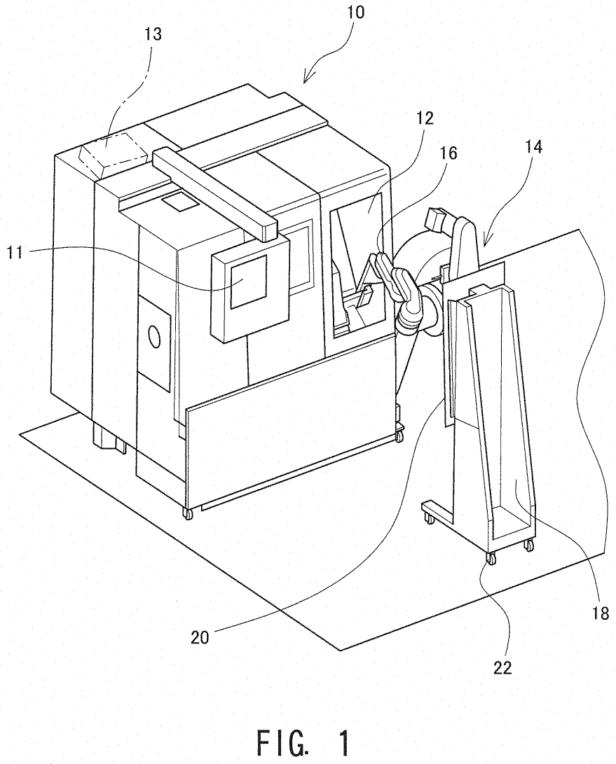

FIG. 1 illustrates a structure of a machine tool system according to an embodiment of the present disclosure. The machine tool system includes a machine tool 10 and a robot unit 14.

The machine tool 10 is a lathe for machining a workpiece, in which the rotating workpiece is machined by bringing a tool held by a tool post into contact with the workpiece. More specifically, the machine tool 10 is a turning center that is numerically controlled (NC controlled) and includes a turret that holds a plurality of tools. A periphery of a machining chamber of the machine tool 10 is covered with a cover, and a portion of the cover has an opening 12. During use of the machine tool, the opening 12 is closed by a lid of a robot unit which will be described later, or a lid which is not shown in drawings.

The machine tool 10 has a known structure. Specifically, the machine tool 10 includes a workpiece spindle device that holds one end of the workpiece in a rotatable manner, a tool post that holds one or more tools, and a tailstock that supports the other end of the workpiece. The workpiece spindle device includes a head stock incorporating, for example, a driving motor, and a workpiece spindle attached to the head stock. The workpiece spindle includes a chuck and a collet that detachably hold the workpiece, and the workpiece held on the workpiece spindle can be changed to another one as needed. The workpiece spindle and the chuck also rotate centered around a workpiece rotational axis.

The tailstock is disposed to oppose the workpiece spindle and supports the other end of the workpiece held by the workpiece spindle. The tailstock is mounted at a position where the center axis of the tailstock is in alignment with the workpiece rotational axis. A center having a tip sharpened in a conical shape is attached to the tailstock, and during a machining process, the tip of the center is brought into contact with a center point of the workpiece.

The tool post holds one or more tools, for example, a tool called a bite. The tool post is movable in the direction parallel to the axis of the workpiece. The tool post is placed on a guide rail extending in the radial direction of the workpiece, and it is also movable back and forth.

The tool post is provided at the tip with a turret that can hold a plurality of tools. As the turret is rotated, the tool to be used for machining the workpiece is changed as needed. A depth of cut into the workpiece or other features of the cut made by one of the tools is changed by moving the tool post.

A controller 13 controls operation of the machine tool 10. The controller 13 controls actuation of components in the machine tool 10 in response to a command from an operator of the machine tool 10. The controller 13 includes, for example, a CPU for performing various computing operations, and a memory for storing various control programs and control parameters. The controller 13 further has a communication function, and can exchange various types of data, for example, NC program data, with other devices. The controller 13 may include, for example, a numerical controller that calculates, when necessary, positions of the tool and the workpiece. The controller 13 may be implemented by a single device or may be composed of a combination of a plurality of processors. The operation state of the machine tool 10 is suitably displayed on an operation panel 11.

Meanwhile, the robot unit 14 includes an articulated robot 16, a base 18, a lid 20, and casters 22. The articulated robot 16 and the lid 20 are provided on the base 18, and the casters 22 are provided on the bottom of the base. The robot unit 14 may have no casters 22, and the base 18 may be moved by, for example, a crane.

With the opening 12 of the cover of the machine tool 10 open, the robot unit 14 is moved toward the machine tool 10, and the articulated robot 16 is inserted into the machining chamber of the machine tool through the opening. The opening 12 is then closed by bringing the lid 20 of the robot unit 14 into contact with a portion surrounding the opening 12. The lid 20 closes the opening 12 with, for example, packing or a labyrinth structure to prevent cutting water from leaking during a machining process.

The articulated robot 16 includes a plurality of links and a plurality of joints that connect the links. An actuator such as a motor is attached to each joint, and actuation of the actuator is controlled by control signals from the controller 13. More specifically, after the robot unit 14 is moved to insert the articulated robot 16 into the machining chamber, the articulated robot 16 and the machine tool 10 are electrically connected and the articulated robot 16 operates in response to a command from the controller 13 of the machine tool. The controller 13 calculates the position of a distal end of the articulated robot 16 based on the amount of actuation of the actuator provided at each joint.

The articulated robot 16 is provided at the distal end with an end effector. The end effector accesses an object and performs a certain action on the object. The end effector may be undetachably attached to the articulated robot, but, in order to enhance the versatility of the articulated robot, it is desirable that the end effector be detachably attached to the articulated robot 16.

Any end effectors configured to perform a certain action may be used without any particular limitation. As such, for example, a holder device for holding an object may be used as an end effector. The holder device may hold an object in any manner such as a hand form in which a pair of components pinches an object therebetween, a form in which an object is held under suction, or a form in which an object is held using magnetic or other force.

The end effector may be, for example, a sensor for sensing information related to the object or an environment around the object. The sensor may include, for example, a contact sensor for detecting contact with the object; a distance sensor for detecting a distance to the object; a vibration sensor for detecting vibrations of the object; a pressure sensor for detecting a pressure applied by the object; or a temperature sensor for detecting a temperature of the object. The results of detection from such a sensor are stored in association with position information of the end effector calculated from the amounts of actuation of the joints, and then analyzed. For example, when a contact sensor serves as the end effector, the controller 13 of the machine tool 10 analyzes the position, shape, and movement of the object based on the time at which contact with the object is detected, and the position information obtained at that time.

A pressing mechanism for pressing the object may be used as an end effector. Specifically, the end effector may be, for example, a roller that is pressed against the workpiece to reduce vibrations of the workpiece. The end effector may be a device for ejecting fluid for assisting machining operations. Specifically, the end effector may be a device for ejecting air for blowing away swarf or a cooling fluid (such as cutting oil, or cutting water) for cooling the tool or the workpiece. Alternatively, the end effector may be a device for emitting energy or a material for forming a workpiece. Accordingly, the end effector may be, for example, a device for emitting laser or arc, or a device for emitting material for lamination forming. Further, in a further embodiment, the end effector may be a camera for capturing an image of the object. In this embodiment, the image captured by the camera may be displayed on, for example, an operation panel.

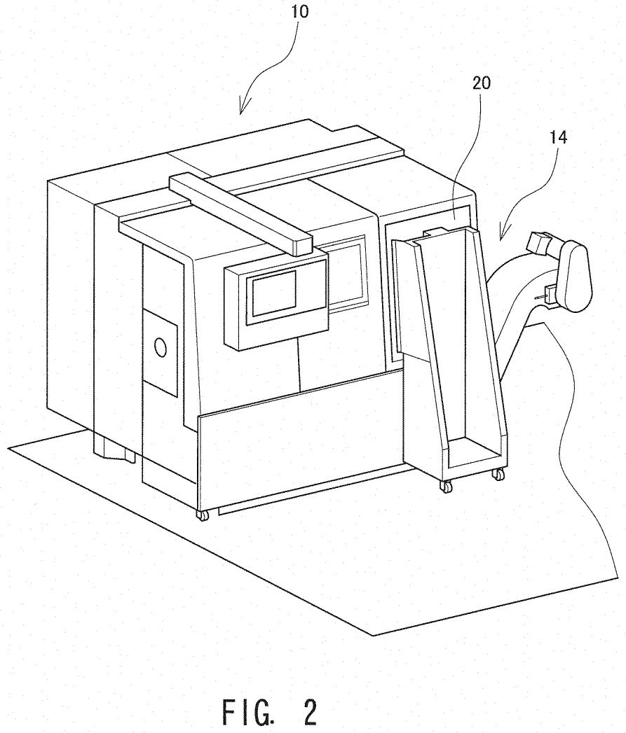

FIG. 2 illustrates a state in which the articulated robot 16 is inserted into the machining chamber and the opening 12 is closed with the lid 20 of the robot unit 14. As the robot unit 14 is placed in position, the portion surrounding the opening 12 is engaged with the lid 20 and the opening 12 is closed with the lid 20. Thereafter, connecting electrical contacts between the articulated robot 16 and the machine tool side enables electrical connection between the articulated robot 16 and the controller 13 of the machine tool 10.

Any positioning mechanism may be used for the robot unit 14. For example, the positioning mechanism may be implemented by bringing an engagement portion located at a predetermined position of the base 18 into engagement with an engagement portion located at a corresponding portion of the machine tool. The positioning mechanism may also be implemented by bringing an engagement portion of the lid 20 into engagement with an engagement portion of the cover of the machine tool 10. The positioning mechanism may also include an electrical connection mechanism, and, by positioning the robot unit 14, the robot unit 14 and the machine tool 10 may be both mechanically and electrically connected to each other. Mechanical connection may encompass a locked state obtained by a locking mechanism.

When connection of the robot unit 14 to the machine tool 10 is detected, the control device 13 of the machine tool 10 may indicate to an operator that connection of the robot unit 14 or the articulated robot 16 to the machine tool 10 has been made by displaying it on an operational panel of the machine tool 10. For example, a message such as “the robot is connected” is displayed on the operational panel. An icon representing the articulated robot 16 may also be displayed on the operational panel. In conjunction with this, the operational panel may display that the articulated robot 16 is available. For example, a message such as “the robot is ready for use” may be displayed on the operational panel.

Further, when the robot unit 14 is not connected, the controller 13 may detect a disconnected state of the robot unit 14 and display it on the operational panel to prompt the operator to connect the robot unit 14. For example, a message such as “the robot is disconnected” may be displayed on the operational panel.

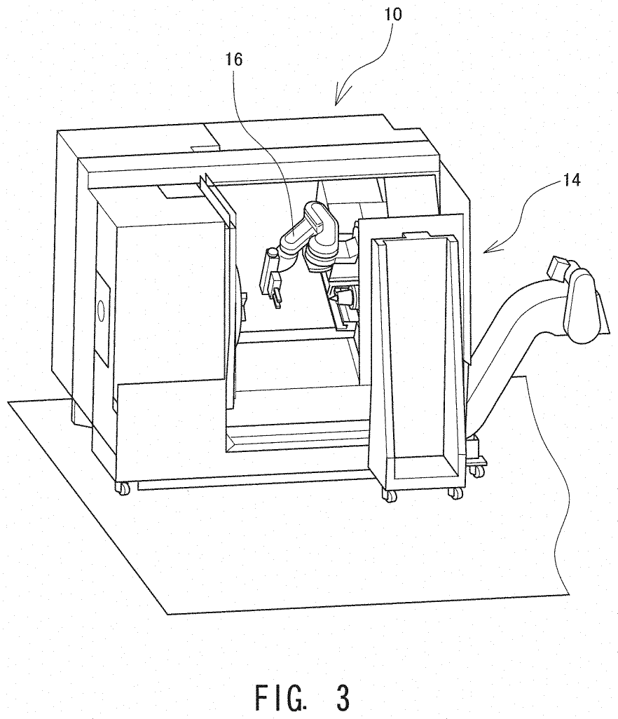

FIG. 3 illustrates a structure in which the inside of the machining chamber is recognizable from outside with the cover of the machine tool 10 partially not shown. The articulated robot 16 of the robot unit 14 moves in the machining chamber according to a command from the controller 13, and performs, for example, gripping of the workpiece, temperature detection of a cutting point by a temperature sensor, imaging of the cutting point by a camera, and supply of cutting water.

The articulated robot 16 includes, for example, a base joint located closest to a root of the robot, and a plurality of parallel joints located adjacently closer to the distal end of the robot than the base joint. The parallel joints may rotate about axes parallel to each other and respectively have rotational axes orthogonal to the rotational axis of the base joint. The structure of the axes and the number of the joints are not limited to the above and can be freely determined. The articulated robot 16 may be configured such that a tool changer is attached to the distal end of the articulated robot 16 via the parallel joints and the links on the extremity portion and the end effector is detachably attached to the tool changer. During a machining process of a workpiece, as the lid 20 of the robot unit 14 closes the opening 12 of the cover of the machine tool 10, swarf and cutting water or the like do not leak to the outside.

The articulated robot 16, which basically moves within the machining chamber, may extend out of the machine tool 10 via a front-door portion that is opened and closed manually or automatically.

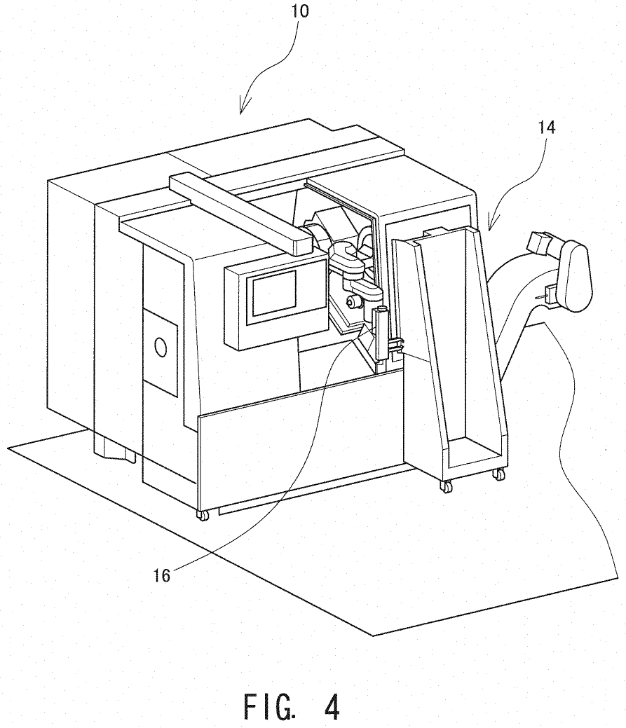

FIG. 4 illustrates a state in which the articulated robot 16 is extended to outside of the machine tool 10 via the front-door portion of the machine tool 10 (the arm of the articulated robot 16 is extended to the outside of the machine). The controller 13 rotationally drives each joint of the articulated robot 16 such that at least a part of the articulated robot 16 including its distal end is extended to the outside of the machine tool 10. This configuration enables accessing a stocker provided in the robot unit 14, where tools or workpieces are set, using the articulated robot 16. This means that connecting the robot unit 14 to the machine tool 10 enables the articulated robot 16 and the stocker for tools and workpieces to connect to the machine tool 10 at the same time.

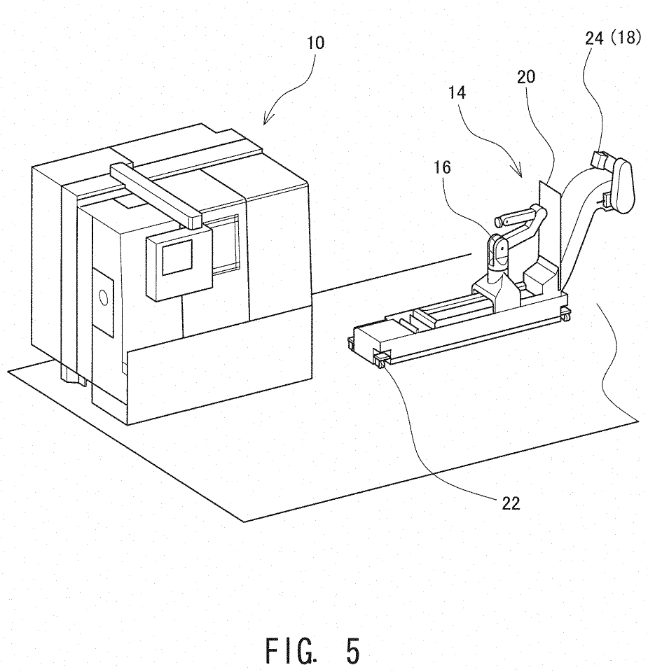

FIG. 5 illustrates a structure of a machine tool system according to another embodiment of the present disclosure. Similarly as in FIG. 1, the robot unit 14 of FIG. 5 also includes the articulated robot 16, the base 18, the lid 20, and the casters 22, and is further integral with a coolant tank 24 for the machine tool.

In the structure shown in FIG. 1, the articulated robot 16 is provided in such a manner as to protrude horizontally from the base 18, while in the structure of FIG. 5, the articulated robot 16 is provided to protrude perpendicularly from the base 18; because the base 18 serving as a weight is located immediately below the articulated robot 16, the stability of the articulated robot 16 installed on the machine tool 10 is enhanced.

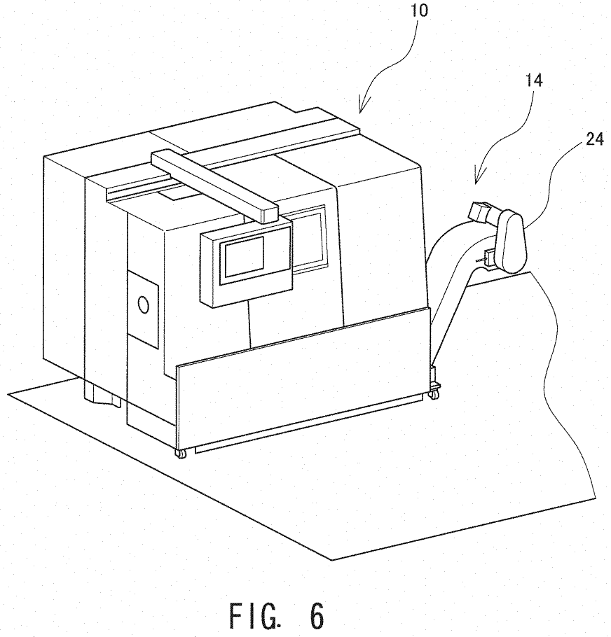

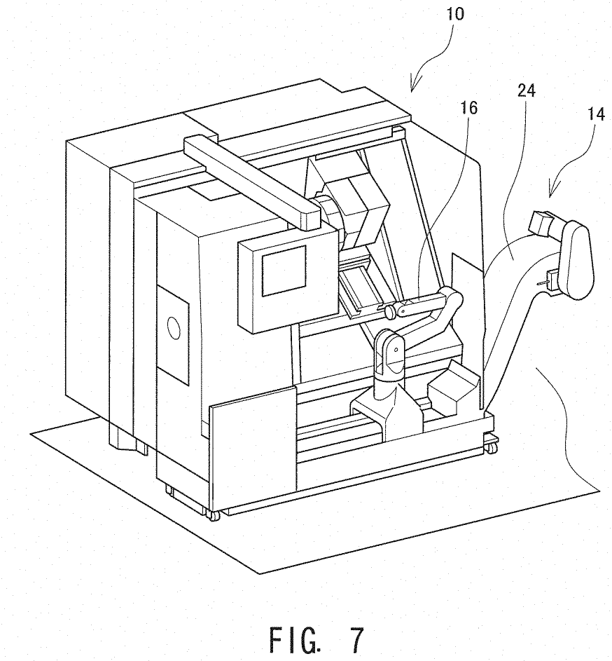

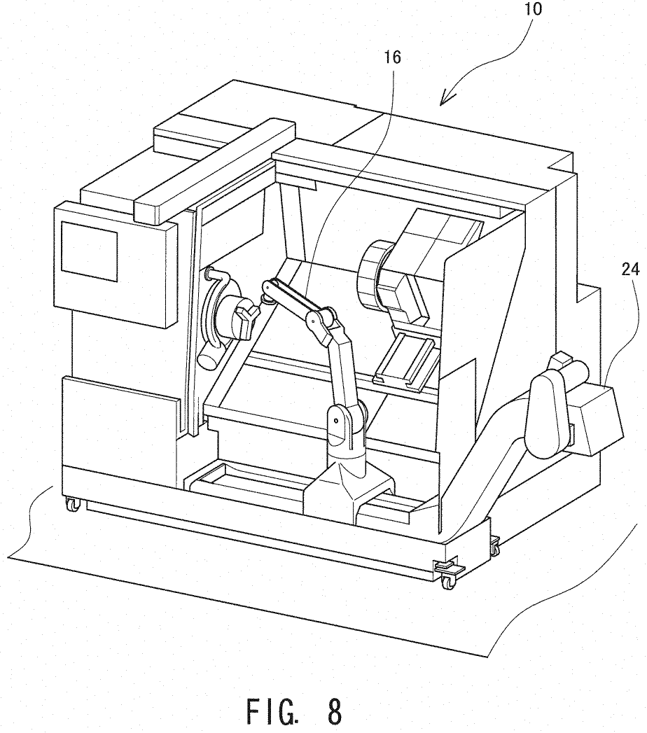

FIG. 6 illustrates a state in which the robot unit 14 is connected to the machine tool 10. FIGS. 7 and 8 show a state in which the cover in FIG. 6 is partially not shown. As shown in FIGS. 7 and 8, as the robot unit 14 is connected to the machine tool 10, the coolant tank 24 integral with the base 18 is also placed in position below the machine tool 10 so that cutting water during a machining process can be received in the coolant tank 24. A risk of leaking of cutting water on a floor, which arises when the base of the robot unit 14 is inserted below the machine tool 10 without integrating with the coolant tank 24, can be eliminated by integrating the robot unit 14 with the coolant tank 24 as in the present embodiment.

As described above, in the illustrated embodiments, as the machine tool 10 and the robot unit 14 are separate devices, the articulated robot 16 is easily installed in or removed from the machine tool 10 as required. The machine tool system can be easily adapted for different purposes by replacing the articulated robot 16 with another robot that suits the new purpose, and then connecting the robot unit 14 to the machine tool 10. Because, when a plurality of machine tools 10 are used, a single robot unit 14 may be used for the plurality of machine tools 10, costs can be reduced because it is not necessary to provide a separate articulated robot 16 for each of the machine tools 10.

While some embodiments of the present disclosure are described above, the embodiments of the present disclosure are not limited to the illustrated embodiments and various modifications can be made.

For example, although, in the above-described embodiments, the robot unit 14 includes a single articulated robot 16, the robot unit 14 may include different types of articulated robots 16 as necessary. Two or more different types of articulated robots 16 may be implemented by attaching a plurality of tool changers to a distal end of a single articulated robot 16 and attaching different end effectors to the plurality of tool changers.

1. A machine tool system, comprising:
a machine tool with a cover that covers a machining space; and
a robot unit on which an articulated robot is mounted,
wherein a portion of the cover of the machine tool has an opening to allow insertion of the articulated robot of the robot unit into the machining space through the opening, and
wherein the robot unit comprises closure means for closing the opening after the articulated robot is inserted.

2. The machine tool system according to claim 1, wherein the robot unit comprises:
a base to which the articulated robot is attached; and
a stocker.

3. The machine tool system according to claim 1, wherein the robot unit further comprises a coolant tank that is integral with the robot unit.

4. The machine tool system according to claim 1, wherein the robot unit further comprises a positioning mechanism for placing the robot unit in position with respect to the machine tool.

5. The machine tool system according to claim 1, wherein a plurality of types of articulated robots are mounted on the robot unit.

6. The machine tool system according to claim 1,
wherein the machine tool comprises a controller for controlling operation of the machine tool, and
wherein a connection of the robot unit to the machine tool enables the controller to control the articulated robot.

7. The machine tool system according to claim 6, wherein the connection of the robot unit to the machine tool causes the controller to indicate that the connection has been made.

8. The machine tool system according to claim 6, wherein the controller causes the articulated robot to extend to outside the machine tool.
